(19) United States
(12) Patent Application Publication
(10) Pub. No.: US 2022/0373998 A1
(43) Pub. Date: Nov. 24, 2022

(54) SENSOR FUSION FOR LINE TRACKING

(71) Applicant: FANUC CORPORATION, Yamanashi (JP)

(72) Inventors: Chiara Talignani Landi, Reggio Emilia (IT); Hsien-Chung Lin, Fremont, CA (US); Tetsuaki Kato, Fremont, CA (US); Chi-Keng Tsai, Bloomfield Hills, MI (US)

(21) Appl. No.: 17/326,841

(22) Filed: May 21, 2021

(51) Int. Cl. G05B 19/418; G06T 7/246; B25J 9/16

(52) U.S. Cl. CPC G05B 19/4182; G06T 7/246; B25J 9/1697; G05B 2219/37189; G05B 2219/40546; G05B 2219/40554

(57) ABSTRACT

A method for determining a position of an object moving along a conveyor belt. The method includes measuring the position of the conveyor belt while the conveyor belt is moving using a motor encoder and providing a measured position signal of the position of the object based on the measured position of the conveyor belt. The method also includes determining that the conveyor belt has stopped, providing a CAD model of the object and generating a point cloud representation of the object using a 3D vision system. The method then matches the model and the point cloud to determine the position of the object, provides a model position signal of the position of the object based on the matched model and point cloud, and uses the model position signal to correct an error in the measured position signal that occurs as a result of the conveyor belt being stopped.

### BACKGROUND

### Field

This disclosure relates generally to a robotic system and method for determining the position of an object moving along a conveyor belt and, more particularly, to a robotic system and method for determining the position of an object moving along a conveyor belt, where the method includes matching a CAD model of the object and a point cloud of the object from a 3D vision sensor to determine the position of the object to correct errors from motor encoder measurements resulting from conveyor belt backlash when the conveyor belt stops.

### Discussion of the Related Art

The use of industrial robots to perform a variety of manufacturing, assembly and material movement operations is well known. In many robot workspace environments, obstacles are present and may be in the path of the robot's motion. The obstacles may be permanent structures such as machines and fixtures, or the obstacles may be temporary or mobile. An object that is being operated on by the robot may itself be an obstacle, as the robot must maneuver in or around the object while performing an operation such as welding. Therefore, various types of collision avoidance and interference check processes are performed during robot operations.

For example, a robot may be performing some production operation, such as screwing, welding or painting, on an object as it is moves along a conveyor belt. The position of the object on the conveyor belt must be known to prevent collisions between the robot and the object and to effectively perform the operation on the object. Currently, motor encoders are often used to identify the position of the conveyor belt and thus the position of the object, where a motor encoder is a rotary encoder mounted to an electric motor that provides closed loop feedback signals by tracking the speed and/or position of a motor shaft. However, a typical conveyor belt for these types of production operations are often stopped and started during the operation for various reasons, which causes the conveyor belt to lurch or backlash, which in turn causes the position measurement from the encoder to have an error and thus makes it difficult to track the object on the conveyor belt.

In one known robotic system that uses a motor encoder to determine the position of an object on a conveyor belt as described also employs cameras that provide images that capture a feature corresponding to the object moving on the conveyor belt, and the system tracks the movement of the feature based on the difference in position between sequential images. From this tracked movement of the object an emulated output signal is generated corresponding to the signal generated by the motor encoder, where the emulated signal is communicated to the robot controller to manage robot operations. However, the vision information is composed by 2D images and image features have to be detected, where the tracking capability relies only on the output of the vision system. Further, a reference point is used to define the position and/or orientation of the object on the conveyor belt. When the moving reference point is synchronized with a fixed reference point having a known position, the processing system is able to computationally determine the position of the object in a known object geometry.

In another known robotic system that uses a motor encoder to determine the position of an object on a conveyor belt as described also approximates the shape of the object with a simple shape, such as a box, sphere or capsule. For the example of a car body that moves on the conveyor belt, the car body is approximated with two boxes, which prevents operations like screwing, welding or interior painting from being performed.

### SUMMARY

The following discussion discloses and describes a robotic system and method for determining the position of an object moving along a conveyor belt. The method includes measuring the position of the conveyor belt while the conveyor belt is moving using a motor encoder and providing a measured position signal of the position of the object based on the measured position of the conveyor belt. The method also includes determining that the conveyor belt has stopped, providing a CAD model of the object and generating a point cloud representation of the object using a 3D vision system, where the point cloud includes points that identify the location of features on the object. The method then matches the CAD model of the object and the point cloud to determine the position of the object, provides a model position signal of the position of the object based on the matched model and point cloud, and uses the model position signal to correct an error in the measured position signal that occurs as a result of the conveyor belt being stopped.

Additional features of the disclosure will become apparent from the following description and appended claims, taken in conjunction with the accompanying drawings.

### BRIEF DESCRIPTION OF THE DRAWINGS

FIG. 1 is an illustration of a robotic system including a robot performing a painting operation on a car body moving along a conveyor belt; and

FIG. 2 is a schematic block diagram of an object position system for determining the position of an object that compensates for conveyor belt backlash errors in the robotic system.

### DETAILED DESCRIPTION OF THE EMBODIMENTS

The following discussion of the embodiments of the disclosure directed to a robotic system and method for determining the position of an object moving along a conveyor belt that compensates for the backlash error when the conveyor belt stops is merely exemplary in nature, and is in no way intended to limit the invention or its applications or uses.

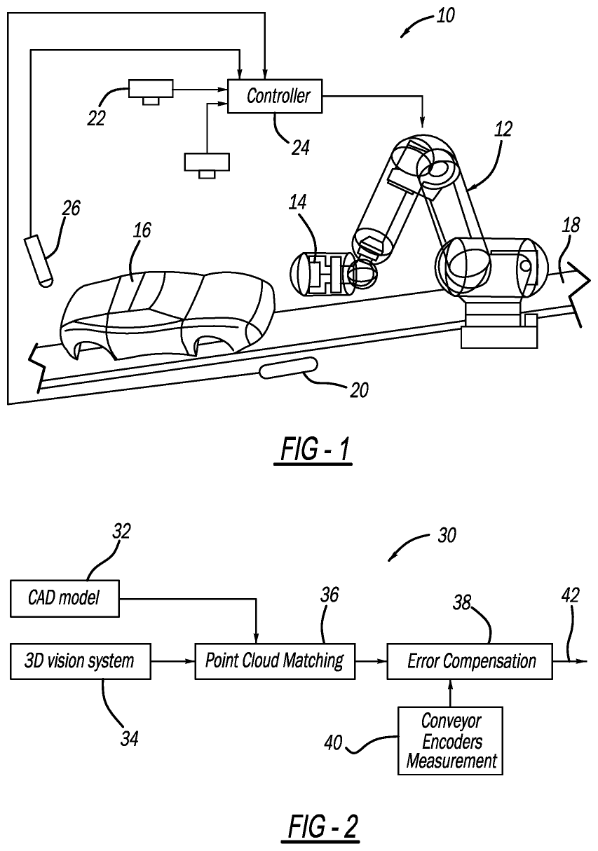

FIG. 1 is an exemplary illustration of a robotic system 10 including a robot 12 having a painting nozzle 14 that is painting a car body 16 as it moves along a conveyor belt 18. The system 10 is intended to represent any type of robotic system that can benefit from the discussion herein, where the robot 12 can be any robot suitable for that purpose. Further, a painting operation and the car body 16 are merely for explanation purposes, where the car body 16 is intended to represent any suitable object and painting is intended to represent any suitable robot operation, where others include welding and fastening. In order for the robot 12 to effectively paint the car body 16 and prevent collisions between the robot 12 and the car body 16, the robot 12 needs to know the precise position of the car body 16 as it moves along the conveyor belt 18. To accomplish this, a conveyor belt motor encoder 20 is provided proximate to the conveyor belt 18 that provides signals to a robot controller 24 indicating the speed that the belt 18 is moving. The system 10 also includes one or more 3D cameras 22 provided at a desired location relative to the conveyor belt 18 and the robot 12 that provides point cloud data to the robot controller 24 that controls the robot 12 to move the painting nozzle 14, where a point cloud is a collection of data points in space that is defined by a certain coordinate system and each point in the point cloud has an x, y and z value. Also, a laser sensor 26 provides a signal to the controller 24 indicating when tracking of the car body 16 should begin.

While the conveyor belt 18 is moving, the position of the car body 16 is being continuously updated using information from the encoder 20. When the conveyor belt 18 stops, the backlash of the belt 18 causes an error in the measurements from the encoder 20 that has to be corrected. During the time that the conveyor belt 18 is stopped, the 3D cameras 22 generate the point cloud that is matched or compared to a CAD model of the car body 16 stored in the controller 24 to compensate for missing points and determine the precise position of the car body 16. The combination of high frequency object position data from the encoder 20 while the belt 18 is moving and low frequency object position data, i.e., matching a point cloud from the 3D cameras 22 and a CAD model of the car body 16, while the belt 18 is stopped allows correction of the measurements from the encoder 20 resulting from belt backlash, and thus precise tracking of the car body 16 on the conveyor belt 18.

FIG. 2 is a schematic block diagram of an object position detection system 30 that determines the position of the car body 16 traveling along on the conveyor belt 18, and compensates for conveyor belt backlash errors, as described above. The system 30 includes a CAD model 32 of the car body 16 and a 3D vision system 34 that provides a point cloud of the car body 16, where the vision system 34 can include one or more 3D cameras or other 3D optical detectors. The CAD model 32 and the point cloud are matched in a point cloud matching processor 36 that operates any suitable point cloud matching algorithm to compensate for missing cloud points and determine the exact position of the car body 16. One suitable algorithm is known as an iterative closest point algorithm, well known to those skilled in the art, that rotates and translates a mesh shape of the CAD model to match or be aligned with the points in the point cloud, where the matched CAD model gives the orientation and position of the car body 16. That position is then sent to an error compensation processor 38 that also receives measurements from a conveyor belt motor encoder 40, representing the encoder 20, that corrects the measurements to provide a position signal on line 42 that identifies a precise position of the car body 16, which can be used to accurately control the robot 12.

The point cloud matching processor 36 provides low frequency position data of the car body 16 that is obtained when the conveyor belt 18 is stopped and the measurements from the encoder 40 provide high frequency position data of the car body 16 while the conveyor belt 18 is moving. Thus, when the conveyor belt 18 is moving, no data is being provided to the error compensation processor 38 from the matching processor 36 and the encoder measurements alone provide the position of the car body 16 on the conveyor belt 18. When the conveyor belt 18 stops, which can be identified by the controller 24 in any suitable manner, and the last position of the conveyor belt 18 provided by the encoder measurements is not accurate because of lurching when the belt 18 stops, the point cloud matching process is performed to correct the measurements from the encoder 40 so that when the belt 18 starts moving again the measurements from the encoder 40 will be accurate. Thus, objects on the conveyor belt 18 are represented by their complex shapes and they are not approximated with simple shapes, hence operations like interior painting, welding or screwing can be accurately performed.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A method for identifying a position of an object moving along a conveyor belt, said method comprising:
measuring the position of the conveyor belt while the conveyor belt is moving;
providing a measured position signal of the position of the object based on the measured position of the conveyor belt;
determining that the conveyor belt has stopped;
providing a model of the object;
generating a point cloud representation of the object using a vision system, where the point cloud includes points that identify the location of features on the object;
matching the model of the object and the point cloud to determine the position of the object;
providing a model position signal of the position of the object based on the matched model and point cloud; and
using the model position signal to correct an error in the measured position signal that occurs as a result of the conveyor belt being stopped.

2. The method according to claim 1 wherein measuring the position of the conveyor belt while the conveyor belt is moving includes using a motor encoder.

3. The method according to claim 1 wherein providing a model of the object includes providing a CAD model.

4. The method according to claim 1 wherein generating a point cloud representation of the object includes using a 3D vision system.

5. The method according to claim 4 wherein the 3D vision system includes at least one 3D camera.

6. The method according to claim 5 wherein the at least one 3D camera is a plurality of 3D cameras.

7. The method according to claim 1 wherein matching the model of the object and the point cloud includes using a point cloud matching algorithm.

8. The method according to claim 7 wherein the point cloud matching algorithm is an iterative closest point algorithm.

9. The method according to claim 1 wherein matching the model of the object and the point cloud includes translating and rotating the model to match feature points in the point cloud.

10. The method according to claim 1 wherein the method is performed in a robot system.

11. A method for identifying a position of an object moving along a conveyor belt, said method being performed by a robot system, said method comprising:
measuring the position of the conveyor belt while the conveyor belt is moving using a motor encoder;
providing a measured position signal of the position of the object based on the measured position of the conveyor belt;
determining that the conveyor belt has stopped;
providing a CAD model of the object;
generating a point cloud representation of the object using a 3D vision system, where the point cloud includes points that identify the location of features on the object;
matching the model of the object and the point cloud to determine the position of the object by translating and rotating the model to match feature points in the point cloud;
providing a model position signal of the position of the object based on the matched model and point cloud; and
using the model position signal to correct an error in the measured position signal that occurs as a result of the conveyor belt being stopped.

12. The method according to claim 11 wherein matching the model of the object and the point cloud includes using an iterative closest point algorithm.

13. A system for identifying a position of an object moving along a conveyor belt, said system comprising:
means for measuring the position of the conveyor belt while the conveyor belt is moving;
means for providing a measured position signal of the position of the object based on the measured position of the conveyor belt;
means for determining that the conveyor belt has stopped;
means for providing a model of the object;
means for generating a point cloud representation of the object using a vision system, where the point cloud includes points that identify the location of features on the object;
means for matching the model of the object and the point cloud to determine the position of the object;
means for providing a model position signal of the position of the object based on the matched model and point cloud; and
means for using the model position signal to correct an error in the measured position signal that occurs as a result of the conveyor belt being stopped.

14. The system according to claim 13 wherein the means for measuring the position of the conveyor belt while the conveyor belt is moving includes uses a motor encoder.

15. The system according to claim 13 wherein the means for providing a model of the object provides a CAD model.

16. The system according to claim 13 wherein the means for generating a point cloud representation of the object using a vision system uses a 3D vision system.

17. The system according to claim 16 wherein the 3D vision system includes at least one 3D camera.

18. The system according to claim 17 wherein the at least one 3D camera is a plurality of 3D cameras.

19. The system according to claim 13 wherein the means for matching the model of the object and the point cloud uses an iterative closest point algorithm.

20. The system according to claim 13 wherein the means for matching the model of the object and the point cloud translates and rotates the model to match feature points in the point cloud.
